(19) United States
(12) Patent Application Publication
(10) Pub. No.: US 2014/0164274 A1
(43) Pub. Date: Jun. 12, 2014

(54) Apparatus and Method for Recommending Courses

(71) Applicants: Xinglong Mai, Chengdu (CN); Hui Hu, Beijing (CN); Qiang Li, Taby (SE); Qingyan Liu, Beijing (CN)

(72) Inventors: Xinglong Mai, Chengdu (CN); Hui Hu, Beijing (CN); Qiang Li, Taby (SE); Qingyan Liu, Beijing (CN)

(73) Assignee: TELEFONAKTIEBOLAGET L M ERICSSON (PUBL), Stockholm (SE)

(21) Appl. No.: 14/007,669

(22) PCT Filed: Apr. 2, 2011
(86) PCT No.: PCT/CN2011/000576

§ 371 Date: Sep. 26, 2013

(51) Int. Cl. G06Q 50/20; G06Q 10/10

(52) U.S. Cl. CPC G06Q 50/2053; G06Q 10/10
USPC 705/327

(57) ABSTRACT

An apparatus for recommending courses (200) comprises: a first receiver (210) adapted to receive a course request from a user client; a first collector (220) adapted to collect user context related to the user client; a first calculator (230) adapted to calculate relevance between the user context and each course stored in a storage device; and a first recommender (240) adapted to recommend courses on the basis of the calculated relevance to the user client. A direct and efficient method for recommending courses based on user context which has a strong impact on user experience is provided. According to the method, user information such as user profile, user behaviors, or past learning activities is not indispensable for the recommendation, and thus cold start problems happening when no user information is available can be solved. The user does not need to input query term(s) when requesting the recommendation, and the recommendation can be performed whenever and wherever the user requests courses.

### TECHNICAL FIELD

The present invention relates to an apparatus and method for recommending courses.

### BACKGROUND

Given the amount of e-learning courses available today and the pace on which the new courses are emerging, it is important for course providers to be able to ensure that users are only presented with courses that are genuinely relevant and timely. Thus, it will only cost end users less time in filtering courses that they are not interested in, and thus they are able to focus on those ones in which they have interest. So far, course providers generally recommend courses to potentially interested users based on user profiles, user behaviors, or past learning activities.

A conventional recommendation method is disclosed in US20080254430A1, wherein recommendation of a learning application program is determined based on the collected profile characteristics and performance data of a user. The main drawback of this conventional recommendation method is that the profile characteristics and performance data of the user is necessary for the recommendation, collection of such information is time-consuming and needs to be done with the aid of the user, and in case such information is not available, the recommendation cannot be performed.

### SUMMARY

An object of the present invention is to provide an improved apparatus and method for recommending courses, which obviates at least some of the above-mentioned disadvantages.

According to a first aspect of the present invention, there is provided an apparatus for recommending courses. The apparatus comprises a first receiver, a first collector, a first calculator, and a first recommender. The first receiver is adapted to receive a course request from a user client, the first collector is adapted to collect user context related to the user client, the first calculator is adapted to calculate relevance between the user context and each course stored in a storage device, and the first recommender is adapted to recommend courses on the basis of the calculated relevance to the user client.

Optionally, each course stored in the storage device contains one ore more keywords each having one or more reference context, and the first calculator comprises a second calculator and a third calculator. The second calculator is adapted to calculate relevance between the user context and the one or more keywords contained in the course as one or more first relevance values, respectively, and the third calculator is adapted to calculate relevance between the user context and the course on the basis of the one or more first relevance values.

Optionally, the second calculator comprises a fourth calculator and a fifth calculator. The fourth calculator is adapted to calculate relevance between the user context and one or more reference context belonging to each keyword among the one ore more keywords, as one or more second relevance values, respectively. And the fifth calculator is adapted to calculate relevance between the user context and the each keyword on the basis of the one or more second relevance values and weights belonging to respective reference context, as one or more first relevance values.

Optionally, the first recommender is adapted to recommend courses whose relevance is higher than a first predefined threshold value to the user client.

Optionally, the apparatus further comprises a second collector and an adjuster. The second collector is adapted to collect feedback from the user client, and the adjuster is adapted to adjust the weights belonging to respective reference context on the basis of the feedback.

Optionally, the keywords and the reference context belonging thereto of the courses stored in the storage device are extracted by an extractor on the basis of contents of the courses.

Optionally, the extractor comprises a generator, a selector, and a classifier. The generator is adapted to generate words by performing word segmentation on the contents of the courses, the selector is adapted to select words whose frequency is higher than a second predefined threshold value and lower than a third predefined threshold value, and the classifier is adapted to classify the selected words as keywords and reference context belonging thereto.

Optionally, the courses are mobile courses.

Optionally, the user context and the reference context include one or more of time, location, season, weather, environment, and event.

According to a second aspect of the present invention, there is provided a method of recommending courses. The method comprises the steps of receiving a course request from a user client, collecting user context related to the user client, calculating relevance between the user context and each course stored in a storage device, and recommending courses on the basis of the calculated relevance to the user client.

Optionally, each course stored in the storage device contains one ore more keywords each having one or more reference context, and the step of calculating relevance between the user context and each course stored in a storage device comprises the steps of calculating relevance between the user context and the one or more keywords contained in the course as one or more first relevance values, respectively, and calculating relevance between the user context and the course on the basis of the one or more first relevance values.

Optionally, the step of calculating relevance between the user context and the one or more keywords contained in the course as one or more first relevance values respectively comprises the steps of calculating relevance between the user context and one or more reference context belonging to each keyword among the one ore more keywords, as one or more second relevance values, respectively, and calculating relevance between the user context and the each keyword on the basis of the one or more second relevance values and weights belonging to respective reference context, as one or more first relevance values.

Optionally, the step of recommending courses on the basis of the calculated relevance to the user client comprises recommending courses whose relevance is higher than a first predefined threshold value to the user client.

Optionally, the method further comprises the following step after the step of recommending courses on the basis of the calculated relevance to the user client: collecting feedback from the user client; and adjusting weights belonging to respective reference context on the basis of the feedback.

Optionally, the keywords and the reference context belonging thereto of the courses stored in the storage device are extracted on the basis of contents of the courses.

Optionally, the extraction comprises the steps of generating words by performing word segmentation on the contents of the courses, selecting words whose frequency is higher than a second predefined threshold value and lower than a third predefined threshold value, and classifying the selected words as keywords and reference context belonging thereto.

Optionally, the courses are mobile courses.

Optionally, the user context and the reference context include one or more of time, location, season, weather, environment, and event.

According to a third aspect of the present invention, there is provided a system for recommending courses. The system comprises a user client, a storage device, and the apparatus according to the present invention.

Optionally, the user client is a mobile device, and communicates with the apparatus via a mobile network.

According to a fourth aspect of the present invention, there is provided a computer program product, comprising a computer readable medium, having stored thereon computer executable codes, when executed, causing a processor to perform the method according to the present invention.

According to a fifth aspect of the present invention, there is provided a computer readable medium, having stored thereon computer executable codes, when executed, causing a processor to perform the method according to the present invention.

According to a sixth aspect of the present invention, there is provided a system for recommending courses. The system comprises a storage device, a user client, and an apparatus for recommending courses. The storage device is adapted to store courses. The user client comprises a third collector adapted to collect user context related to the user client, and a transmitter adapted to transmit a course request and the user context to an apparatus for recommending courses. The apparatus for recommending courses comprises a second receiver adapted to receive the course request and the user context from the user client, a sixth calculator adapted to calculate relevance between the user context and each course stored in the storage device, and a second recommender adapted to recommend courses on the basis of the calculated relevance to the user client.

Thus, the present invention provides a direct and efficient approach for recommending courses based on user context which has a strong impact on user experience. According to the present invention, user information such as user profiles, user behaviors, or past learning activities is not indispensable for the recommendation, and thus cold start problems happening when no user information is available can be solved. The user does not need to input query term(s) when requesting the recommendation, and the recommendation can be performed whenever and wherever the user requests courses.

### BRIEF DESCRIPTION OF THE DRAWINGS

The accompanying drawings are included to provide a further understanding of embodiments and are incorporated in and constitute a part of this description. The drawings illustrate embodiments and together with the description serve to explain principles of embodiments. The elements of the drawings are not necessarily to scale relative to each other. Like reference numerals designate corresponding similar parts. It should be expressly understood that the drawings are included for illustrative purposes and do not in any manner limit the scope of the present invention.

FIG. 1 is a block diagram illustrating an apparatus for recommending courses according to an embodiment of the present invention;

FIG. 2 is a block diagram illustrating a first calculator included in the apparatus according to an embodiment of the present invention;

FIG. 3 is a table illustrating construction of model sets of a course according to an embodiment of the present invention;

FIG. 4 is a table illustrating exemplary model sets of a course according to an embodiment of the present invention;

FIG. 5 is a flow chart illustrating a method of recommending courses according to an embodiment of the present invention;

FIG. 6 is a flow chart illustrating a step of calculating relevance between the user context and each course stored in a storage device according to an embodiment of the present invention;

FIG. 7 is a flow chart illustrating a step of calculating relevance between the user context and the one or more keywords contained in the course as one or more first relevance values respectively according to an embodiment of the present invention;

FIG. 8 is a block diagram illustrating a system for recommending courses according to an embodiment of the present invention;

FIG. 9 is a block diagram illustrating an application server according to an embodiment of the present invention; and

FIG. 10 is a block diagram illustrating an illustrative system for recommending courses according to an embodiment of the present invention.

### DETAILED DESCRIPTION

In the following description, for purposes of explanation rather than limitation, specific details, such as the particular architecture, structure, techniques, etc., are set forth for illustration. However, it will be apparent to those of ordinary skill in the art that other embodiments that depart from these specific details would still be understood to be within the scope of the present invention. Moreover, for the purpose of clarity, detailed descriptions of well-known devices, circuits, and methods are omitted so as not to obscure the description of the present invention. It is to be understood that the features of the various exemplary embodiments described herein may be combined with each other, unless specifically noted otherwise.

FIG. 1 is a block diagram illustrating an apparatus 200 for recommending courses according to an embodiment of the present invention. As shown in FIG. 1, the apparatus 200 comprises a first receiver 210 adapted to receive a course request from a user client. According to actual condition and demand, the first receiver 210 can be one of various receivers known in the art compatible with existing communication protocols/standards, such as GSM (Global System for Mobile Communication), WCDMA (Wideband CDMA), CDMA2000, WiFi (Wireless Fidelity), LTE (Long Term Revolution), WiMAX (Worldwide Interoperability for Microwave Access), etc. Optionally, the user client is a mobile device, such as mobile phone, tablet computer, laptop, PDA (Personal Digital Assistant), portable audio/video player, etc; optionally and accordingly, the courses are mobile courses. Hereinafter, the present invention will be described with respect to the mobile device and the mobile courses. However, such description is only exemplary, rather than restrictive, and the present invention may also apply to other kinds of user clients and courses, such as a desktop computer or a television set with internet access and corresponding video and/or audio courses.

As shown in FIG. 1, the apparatus 200 further comprises a first collector 220 adapted to collect user context related to the user client. According to an embodiment of the present invention, the user context includes one or more of time, location, season, weather, environment, event, etc of a user's mobile device or in a predetermined location related to the mobile device. The first collector 220 can adopt one or more of various appropriate collecting techniques known in the art. For example, with respect to the mobile device, time information may for example be collected by invoking a time parameter of the mobile device, which is synchronized with a time server of a local operator for the mobile device; thus, season information can be collected based on the time information; location information may for example be collected by invoking a coordinate parameter of a GPS (Global Positioning System) module of the mobile device or from a positioning service provided by the local operator; weather information, environment information and event information can be collected from a online database based on the collected time information and location information. It should be noted that the above-described approaches for collecting the user context are only exemplary, rather than restrictive, and various appropriate collecting techniques can be adopted.

The apparatus 200 further comprises a first calculator 230 adapted to calculate relevance between the user context and each course stored in a storage device. Optionally, the storage device (not shown in FIG. 1) may be one or more of various storage devices known in the art, such as hard disk, optical disk, etc, which is attached to the apparatus 200 or connected to the apparatus 200 via a network. The courses provided by course providers are pre-stored in the storage device for example in an exemplary form of model sets described hereinafter.

The model sets are dynamic sets defining multidimensional tables or spaces, which are able to self-learn based on users' feedback. For instance, the space may be in the form of [keyword, reference context, weight]. Similarly with the above-described user context, the reference context includes one or more of time, location, season, weather, environment, event, etc.

FIG. 3 is a table illustrating construction of model sets of a course according to an embodiment of the present invention. According to an embodiment of the present invention, the keywords and the reference context belonging thereto shown in the table are extracted by an extractor on the basis of contents of the courses. The contents of the courses may be course description, handouts, textbooks, or other information related to the courses.

According to an embodiment of the present invention, the extractor comprises a generator adapted to generate words by performing word segmentation on the contents of the courses. The word segmentation for e.g. English and Chinese languages is different. English sentences are constructed by words, and word boundaries are clearly delimited by space characters and punctuation marks. Thus, words segmentation for English sentences can be easily done by means of space characters and punctuation marks. However, a Chinese sentence consists of one or more Chinese characters, and there are no explicit word boundaries, which makes segmentation of Chinese sentences a complicated task. There exist several kinds of Chinese sentence segmentation (identification) approaches, which generally fall into the following three categories: dictionary-based approaches, statistical approaches, and hybrid approaches. In general, very high identification rates (usually 80%˜98%) can be achieved. And there also exist many usable algorithms and projects for these approaches, such as poading, imdict (ICTCLAS), mmseg4j, ik, GIZA++.

The extractor further comprises a selector adapted to select words whose frequency is higher than a predefined lower threshold value and lower than a predefined higher threshold value, and a classifier adapted to classify the selected words as keywords and reference context belonging thereto. The above two predefined threshold values adopted by the selector may be used to filter out low frequency words and unproductive words such as “this”, “but”, names of people, etc, and can be predetermined according to actual condition and demand. The classifier may classify the selected words containing meaningful noun as keywords, and classify the selected words containing information such as time, season, number, location, weather, etc as reference context belonging to corresponding. keywords.

In the table as shown in FIG. 3, the weight may be for example an integer, and the initial value of a weight of an item [keyword, reference context, weight] may be predefined as 0 or 1 based on empirical data or history data. When getting feedback from a user's mobile device, i.e., whether a certain recommended course is accepted by the user, weights may be accordingly adjusted. For example, if the user accepts this course, the weights of all items of [keyword, reference context, weight] in this course may be increased by one; otherwise, if the user does not accept this course, the weights of all the items may be decreased by one. The weight can be a negative value (e.g., −1), zero, or a positive value (e.g., 3).

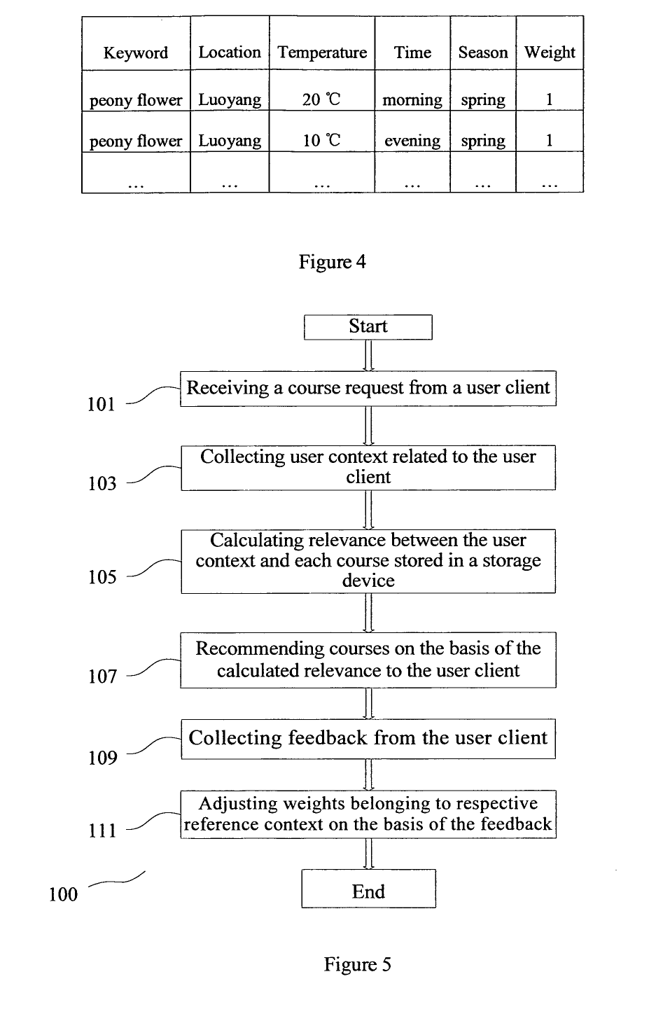

An example of construction of model sets for a course will be described with reference to FIG. 4, which shows a table illustrating exemplary model sets of a course “how to plant peony flower”. Firstly, the generator in the extractor according to an embodiment of the present invention may generate words by performing word segmentation on the contents of this course. Then, the selector in the extractor may select “peony flower”, “Luoyang”, “spring”, “morning”, “evening”, “10° C.”, “20° C.”, etc. Subsequently, the classifier in the extractor may classify “peony flower” as a keyword, and classify “Luoyang”, “spring”, “morning”, “evening”, “10° C.”, “20° C.”, etc as reference context belonging to a respective keyword. Optionally, a keyword may also be manually connected with corresponding reference context. After constructing the model sets, they can be manually checked and modified, so as to avoid empty or apparently faulty model sets.

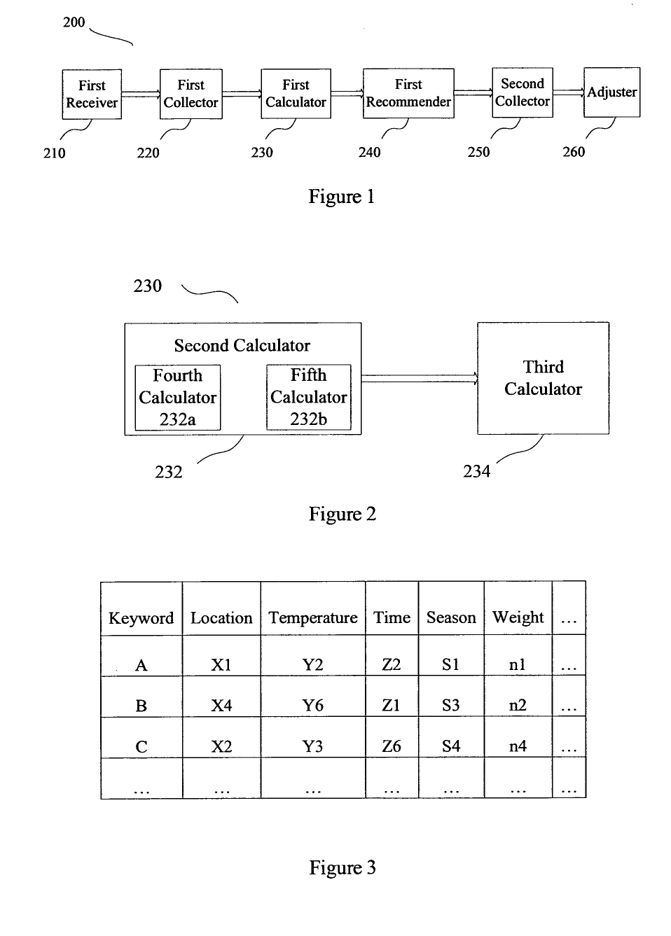

Referring back to FIG. 1 and FIG. 2 illustrating the first calculator 230 in the apparatus, according to an embodiment of the present invention, the first calculator 230 comprises a second calculator 232 adapted to calculate relevance between user context and keyword(s) of a course as first relevance value(s), respectively, and a third calculator 234 adapted to calculate relevance between the user context and the course on the basis of the first relevance value(s). Optionally, the second calculator 232 further comprises a fourth calculator 232a adapted to calculate relevance between the user context and reference context belonging to each keyword, as second relevance value(s), respectively, and a fifth calculator 232b adapted to calculate relevance between the user context and the each keyword on the basis of the second relevance value(s) and weights belonging to respective reference context, as one or more first relevance values.

Hereinafter, an example will be described in order to explain the operations of the first calculator 230. In this example, there are four context dimensions: location, time, season, and temperature, which forms a 4-dimensional hyper space. The model space contains NN records.

Read received user context as Cₜ(Location, Time, Season, Temperature), t herein means timing. Read each set in model sets as A(keywordᵢ, Cᵢ, Wᵢ), wherein reference context is Cᵢ(Location, Time, Season, Temperature) and Wᵢ is the weight. Here, i ranges from 0 to NN−1.

In order to calculate relevance between Cₜ and Cᵢ, optionally a difference Diff(Cₜ, Cᵢ) between Cₜ and Cᵢ is calculated. Firstly, a difference D_{L}′ between Cₜ(Location) and Cᵢ(Location) is calculated and then normalized into the value region [0, 1], so as to obtain a difference D_{L}. Secondly, a difference D_{T}′ between Cₜ(Temperature) and Cᵢ(Temperature) is calculated and then normalized into the value region [0, 1], so as to obtain a difference D_{T}. Similar difference calculation and normalization can be performed to obtain a normalized time difference Dₜ and a normalized season difference D_{S}. Finally, all the four differences are summed and then normalized into the value region [0, 1] as follows:

Diff(Cₜ, Cᵢ)=sum(D_{L}+D_{T}+Dₜ+D_{S})/4

Conventional normalization methods such as exponential function (e.g., f=1−exp(−x)) can be used herein. A precise mapping function can be obtained by statistical analysis on the original difference values.

Then, relevance R(Ct, Ci) between Ct and Ci can be calculated by the fourth calculator 232a comprised in the second calculator 232 based on the calculated Diff(Cₜ, Cᵢ). A relevance value of 1 means that two vectors are identical and their relevance is 1, and a relevance value of 0 means that their relevance is 0.

Optionally, a decreasing function R(Cₜ, Cᵢ)=f(Diff(Cₜ, Cᵢ)), such as R=1−Dist(Cₜ, Cᵢ), can be adopted. The range of R(Cₜ, Cᵢ) is [0, 1].

Subsequently, relevance R(Cₜ, keywords) between Cₜ and each keyword can be calculated by the fifth calculator 232b comprised in the second calculator 232 based on the calculated R(Cₜ, Cᵢ). In the model sets, a keyword Kᵢ may contain Nᵢ groups of reference context, and the total number of keywords is assumed to be M. The relevance between each keyword and the user context Cₜ is calculated as Rᵢ(Cₜ, Kᵢ). The range of i is [0, M−1].

Rᵢ(Cₜ, Kᵢ)=sum(Wᵢ₁*R(Cₜ, Cᵢ₁), . . . , Wᵢₖ*R(Cₜ, Cᵢₖ), . . . , W_{iNi}*R(Cₜ, C_{iNi})) wherein Wᵢ(Wᵢ₀˜W_{iNi}) are a set of weights of the reference context of the keyword Ki.

Finally, relevance R(Cₜ, course) between Cₜ and each course can be calculated by the third calculator 234 based on the calculated Rᵢ(Cₜ, Kᵢ). Optionally, each course can be represented as course((keyword₁, frequency₁), . . . , (keyword_{M}, frequency_{M})), and the frequency is a statistical result on how many times a keyword can be found in the course content. Several approaches can be used such as the TF-IDF algorithm in the Lucene project for the statistics.

For a certain course, R(Cₜ, course) can be calculated as follows:

R(Cₜ, course)=sum(f₁*R₀(Cₜ, K₀), . . . , fₙ*Rₙ(Cₜ, Kₙ))

It should be noted that the above detailed example is only an example for exemplifying the operations of the first calculator 230, rather than restrictive, and other appropriate approaches can also be employed to achieve the function of the first calculator 230.

Referring back to FIG. 1, the apparatus 200 further comprises a first recommender 240 adapted to recommend courses on the basis of the calculated relevance to the user client. According to an embodiment of the present invention, the courses are arranged in a descending order of relevance with the user context, and the first recommender 240 recommends courses whose relevance is higher than a specific predefined threshold value to the user client, in which the specific predefined threshold value can be determined according to actual condition and demand. Optionally, the list containing the recommended courses arranged in the descending order of relevance may be transmitted to the user's mobile device and displayed on a screen of the mobile device.

According to an embodiment of the present invention, the apparatus 200 further comprises a second collector 250 adapted to collect feedback from the user client and an adjuster 260 adapted to adjust the weights belonging to respective reference context on the basis of the feedback. As described above with respect to the concept of weight, when the user provides feedback, i.e., whether a certain recommended course is accepted by the user, the second collector 250 collects the feedback, and the adjuster 260 accordingly adjusts respective weights. For example, with respect to the recommended course accepted by the user, the weights of all items of [keyword, reference context, weight] in this course may for example be increased by one; with respect to the recommended course not accepted by the user, the weights of all the items may for example be decreased by one. The weight can be a negative value (e.g., −1), zero, or a positive value (e.g., 3). The weights of the items in the course are adjusted based on the user's feedback, so that more precise and suitable recommendation can be provided when a user's mobile device with same or similar user context requests recommendation in the future.

FIG. 5 is a flow chart illustrating a method 100 of recommending courses according to an embodiment of the present invention. Optionally, the method 100 can be performed by the above-described apparatus 200 according to the present invention.

As shown in FIG. 5, the method 200 begins with a step 101 of receiving a course request from a user client. Optionally, the step 101 can be performed by the above-described first receiver 210 of the apparatus 200 according to the present invention. According to actual condition and demand, the step 101 can adopt one of various receiving techniques known in the art compatible with existing communication protocols/standards, such as GSM (Global System for Mobile Communication), WCDMA (Wideband CDMA), CDMA2000, WiFi (Wireless Fidelity), LTE (Long Term Revolution), WiMAX (Worldwide Interoperability for Microwave Access), etc. Optionally, the user client is a mobile device, such as mobile phone, tablet computer, laptop, PDA (Personal Digital Assistant), portable audio/video player, etc; optionally and accordingly, the courses are mobile courses. Also, the present invention may apply to other kinds of user clients and courses, such as a desktop computer or a television set with internet access and corresponding video and/or audio courses.

Then, in a step 103, user context related to the user client is collected. Optionally, the step 103 can be performed by the above-described first collector 220 of the apparatus 200 according to the present invention. According to an embodiment of the present invention, the user context includes one or more of time, location, season, weather, environment, event, etc of a user's mobile device or in a predetermined location related to the mobile device. One or more of various appropriate collecting techniques known in the art can be adopted in the step 103, such as the approaches described above with respect to the first collector 220.

Then, in a step 105, relevance between the user context and each course stored in a storage device is calculated. Optionally, the step 105 can be performed by the above-described first calculator 230 of the apparatus 200 according to the present invention. Optionally, the storage device may be one of various storage devices known in the art, such as hard disk, optical disk, etc. The courses provided by course providers are pre-stored in the storage device for example in the exemplary form of model sets described with reference to FIG. 3.

The model sets are dynamic sets defining multidimensional tables or spaces, which are able to self-learn based on users' feedback. For instance, the space may be in the form of [keyword, reference context, weight]. Similarly with the above-described user context, the reference context includes one or more of time, location, season, weather, environment, event, etc.

According to an embodiment of the present invention, the keywords and the reference context belonging thereto shown in the table of FIG. 3 are extracted on the basis of contents of the courses. The contents of the courses may be course description, handouts, textbooks, or other information related to the courses. Optionally, the extraction can be performed by the above-described extractor according to the present invention.

According to an embodiment of the present invention, the extraction comprises the steps of: generating words by performing word segmentation on the contents of the courses, which can be optionally performed by the above-described generator according to the present invention; selecting words whose frequency is higher than a second predefined threshold value and lower than a third predefined threshold value, which can be optionally performed by the above-described selector according to the present invention; and classifying the selected words as keywords and reference context belonging thereto, which can be optionally performed by the above-described classifier according to the present invention.

The above description related to the detailed operations of the generator, the storage, and the classifier of the extractor also applies to the steps of generating, selecting and classifying comprised in the extraction, and is thus not iterated for the sake of conciseness.

In the table as shown in FIG. 3, the weight may be for example an integer, and the initial value of a weight of an item [keyword, reference context, weight] may be predefined as 0 or 1 based on empirical data or history data. When getting feedback from a user's mobile device, i.e., whether a certain recommended course is accepted by the user, weights may be accordingly adjusted.

Further, the above description of the example of construction of model sets for a course with reference to FIG. 4 also applies to the method 100, and is thus not iterated for the sake of conciseness.

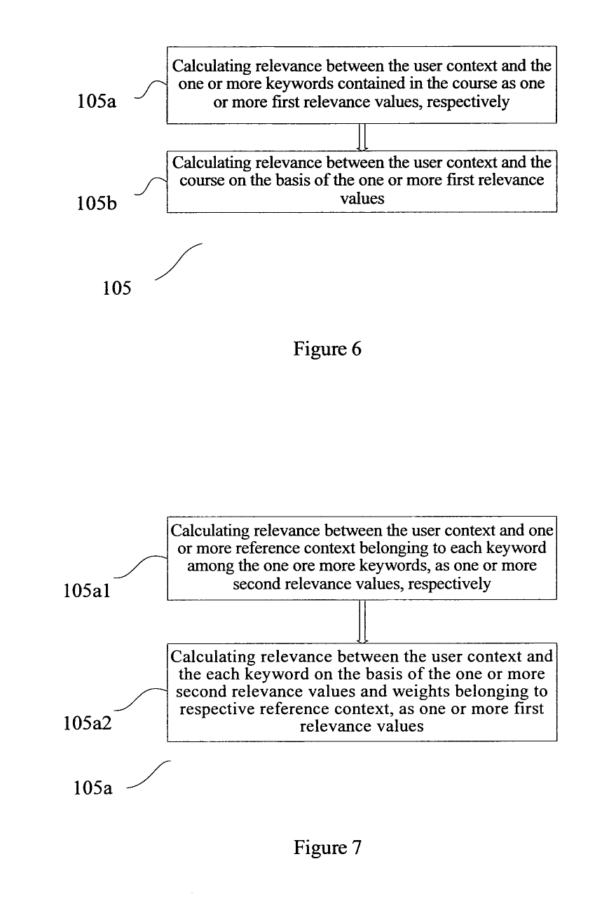

Referring again to FIG. 5 and FIG. 6 illustrating the step 105 of calculating relevance between the user context and each course, according to an embodiment of the present invention, the step 105 comprises a step 105a of calculating relevance between user context and keyword(s) of a course as first relevance value(s), respectively, and a step 105b of calculating relevance between the user context and the course on the basis of the first relevance value(s). As shown in FIG. 7 illustrating the step 105a, optionally, the step 105a further comprises a step 105a1 of calculating relevance between the user context and reference context belonging to each keyword, as second relevance value(s), respectively, and a step 105a2 of calculating relevance between the user context and the each keyword on the basis of the second relevance value(s) and weights belonging to respective reference context, as one or more first relevance values. Optionally, the steps 105a, 105b, 105a1, and 105a2 can be performed by the above-described second calculator 232, the third calculator 234, the fourth calculator 232a, and the fifth calculator 232b of the first calculator 230 according to the present invention, respectively.

Further, the above description for the example of the detailed operations of second calculator 232, the third calculator 234, the fourth calculator 232a, and the fifth calculator 232b of the first calculator 230 also applies to the steps 105a, 105b, 105a1, and 105a2 comprised in the step 105, and is thus not iterated for the sake of conciseness.

Referring back to FIG. 5, the method 100 further comprises a step 107 of recommending courses on the basis of the calculated relevance to the user client, which can optionally be performed by the above-described first recommender 240 according to the present invention. According to an embodiment of the present invention, the courses are arranged in a descending order of relevance with the user context, and courses whose relevance is higher than a specific predefined threshold value are recommended to the user client, in which the specific predefined threshold value can be determined according to actual condition and demand. Optionally, the list containing the recommended courses arranged in the descending order of relevance may be transmitted to the user's mobile device and displayed on a screen of the mobile device.

According to an embodiment of the present invention, the step 107 comprises a step 109 of collecting feedback from the user client and a step 111 of adjusting weights belonging to respective reference context on the basis of the feedback. Optionally, the steps 109 and 111 can be performed by the above-described second collector 250 and the adjuster 260 according to the present invention, respectively. As described above with respect to the concept of weight, when the user provides feedback, i.e., whether a certain recommended course is accepted by the user, the feedback is collected in the step 109, and respective weights are accordingly adjusted in the step 111. For example, with respect to the recommended course accepted by the user, the weights of all items of [keyword, reference context, weight] in this course may for example be increased by one; with respect to the recommended course not accepted by the user, the weights of all the items may for example be decreased by one. The weight can be a negative value (e.g., −1), zero, or a positive value (e.g., 3). The weights of the items in the course are adjusted based on the user's feedback, so that more precise and suitable recommendation can be provided when a user's mobile device with same or similar user context requests recommendation in the future.

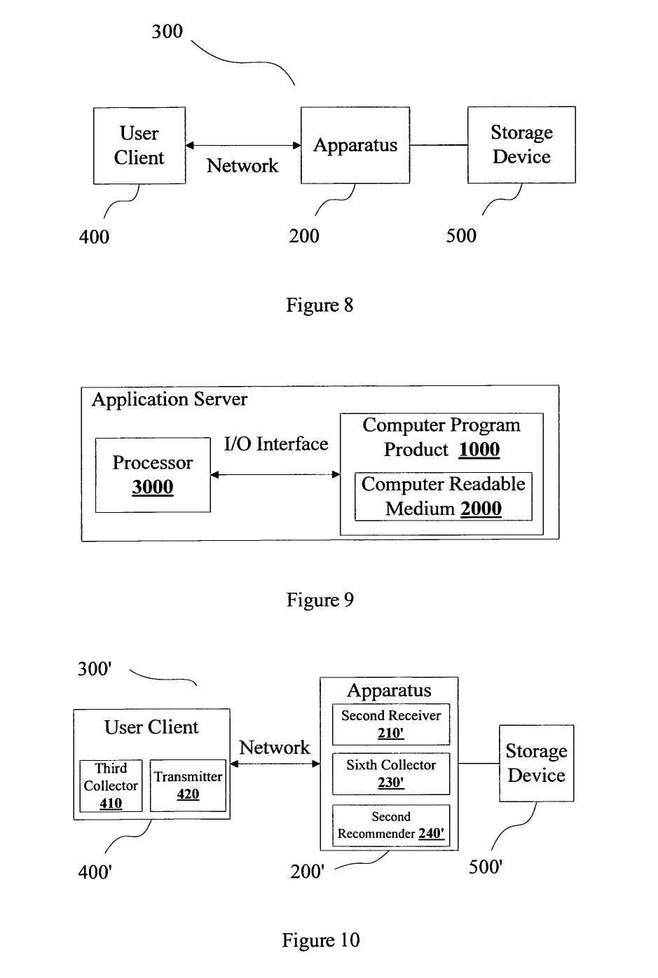

FIG. 8 is a block diagram illustrating a system 300 for recommending courses according to an embodiment of the present invention. The system 300 comprises a user client 400, a storage device 500, and the apparatus 200 according to the present invention. The interactions between the apparatus 200, the user client 400, and the storage device 500 are similar with those described above with respect to the apparatus 200, and are thus not iterated in details for the sake of conciseness.

Embodiments of the present invention may be implemented in hardware, or as software modules running on one or more processors, or in a combination thereof. That is, those skilled in the art will appreciate that special hardware circuits such as Application Specific Integrated Circuits (ASICs) or Digital Signal Processors (DSPs) may be used in practice to implement some or all of the functionality of all components of the apparatus 200 according to an embodiment of the present invention. Some or all of the functionality of the components of the apparatus 200 may alternatively be implemented by a processor of an application server in combination with e.g. a computer program product comprising a computer readable medium having stored thereon computer executable codes, which computer executable codes when executed on the processor causes the application server to perform, for example, the steps of the method 100 according to an embodiment of the present invention. FIG. 9 shows a block diagram illustrating such application server. In the application server, a computer program product 1000, comprising a computer readable medium 2000 having stored thereon computer executable codes, is interfaced with a processor 3000. The computer executable codes when executed on the processor 3000 causes the application server to perform the steps of the method 100 according to the present invention.

The present invention may also be embodied as one or more device or apparatus programs (e.g. computer programs and computer program products) for carrying out part(s) or all of the steps of the method 100 described herein. Such programs embodying the present invention may be stored on computer readable medium, or could, for example, be in the form of one or more signals. Such signals may be data signals downloadable from an Internet website, or provided on a carrier signal, or in any other forms.

As an alternative to the above system 300 according to the present invention, the present invention provides an alternative system 300′ for recommending courses according to an embodiment of the present invention, which is illustrated in FIG. 10. The system 300′ comprises: a storage device 500′ adapted to store courses; a user client 400′ comprising a third collector 410 adapted to collect user context related to the user client 400′ and a transmitter 420 adapted to transmit a course request and the user context to an apparatus for recommending courses; and the apparatus 200′ for recommending courses comprising a second receiver 210′ adapted to receive the course request and the user context from the user client, a sixth calculator 230′ adapted to calculate relevance between the user context and each course stored in the storage device, and a second recommender 240′ adapted to recommend courses on the basis of the calculated relevance to the user client.

The difference between the above-described alternative system 300′ and the system 300 is that in the alternative system 300′, it is the third collector 410 comprised in the user client 400′ that collects user context related to the user client 400′, rather than the first collector 220 comprised in the apparatus 200 as exemplified hereinbefore. Similarly, the third collector 220 can adopt one or more of various appropriate collecting techniques known in the art, such as the approaches described above with respect to the first collector 220. Further, the third collector 220 may for example comprise a sensor for sensing weather information such as temperature, humidity, wind, etc of the use client 400′. It is appreciated by those skilled in the art that the optional embodiments described hereinbefore for the system 300 (for the apparatus 200) may also apply to this alternative system 300′.

Thus, the present invention provides a direct and efficient approach for recommending courses based on user context which has a strong impact on user experience. According to the present invention, user information such as user profiles, user behaviors, or past learning activities is not indispensable for the recommendation, and thus cold start problems happening when no user information is available can be solved. The user does not need to input query term(s) when requesting the recommendation, and the recommendation can be performed whenever and wherever the user requests courses. Further, more precise and suitable course recommendation can be achieved by employing the user context. In addition, course construction containing model sets which is more effective and suitable for course recommendation is provided.

It should be noted that the aforesaid embodiments are exemplary rather than limiting the present invention, substitute embodiments may be designed by those skilled in the art without departing from the scope of the claims enclosed. The word “include” does not exclude elements or steps which are present but not listed in the claims. The word “a” or “an” preceding the elements does not exclude the presence of a plurality of such elements. In the apparatus claims that list several components, several ones among these components can be specifically embodied in the same hardware item. The use of such words as first, second, third does not represent any order, which can be simply explained as names.

1-23. (canceled)

24. An apparatus for recommending courses, the apparatus comprising:
a first receiver adapted to receive a course request from a user client;
a first collector adapted to collect user context related to the user client, wherein the user context includes one or more of time, location, season, weather, environment, and event;
a first calculator adapted to calculate relevance between the user context and each course stored in a storage device; and
a first recommender adapted to recommend courses on the basis of the calculated relevance to the user client.

25. The apparatus of claim 24, wherein each course stored in the storage device contains one or more keywords each having one or more reference context, and wherein the first calculator comprises:
a second calculator adapted to calculate relevance between the user context and the one or more keywords contained in the course as one or more first relevance values, respectively; and
a third calculator adapted to calculate relevance between the user context and the course on the basis of the one or more first relevance values.

26. The apparatus of claim 25, wherein the second calculator comprises:
a fourth calculator adapted to calculate relevance between the user context and one or more reference context belonging to each keyword among the one or more keywords, as one or more second relevance values, respectively; and
a fifth calculator adapted to calculate relevance between the user context and the each keyword on the basis of the one or more second relevance values and weights belonging to respective reference context, as one or more first relevance values.

27. The apparatus of claim 26, further comprising:
a second collector adapted to collect feedback from the user client; and
an adjuster adapted to adjust the weights belonging to respective reference context on the basis of the feedback.

28. The apparatus of claim 25, further comprising an extractor adapted to extract the keywords and the reference context belonging thereto of the courses stored in the storage device, on the basis of contents of the courses.

29. The apparatus of claim 28, wherein the extractor comprises:
a generator adapted to generate words by performing word segmentation on the contents of the courses;
a selector adapted to select words whose frequency is higher than a second predefined threshold value and lower than a third predefined threshold value; and
a classifier adapted to classify the selected words as keywords and reference context belonging thereto.

30. The apparatus of claim 24, wherein the first recommender is adapted to recommend courses whose relevance is higher than a first predefined threshold value to the user client.

31. The apparatus of claim 24, wherein the courses are mobile courses.

32. The apparatus of claim 24, wherein the reference context include one or more of time, location, season, weather, environment, and event.

33. A method of recommending courses, comprising the steps of:
receiving a course request from a user client;
collecting user context related to the user client, wherein the user context includes one or more of time, location, season, weather, environment, and event;
calculating relevance between the user context and each course stored in a storage device; and
recommending courses on the basis of the calculated relevance to the user client.

34. The method of claim 33, wherein each course stored in the storage device contains one or more keywords each having one or more reference context, and wherein the step of calculating relevance between the user context and each course stored in a storage device comprises the steps of:
calculating relevance between the user context and the one or more keywords contained in the course as one or more first relevance values, respectively; and
calculating relevance between the user context and the course on the basis of the one or more first relevance values.

35. The method of claim 34, wherein the keywords and the reference context belonging thereto of the courses stored in the storage device are extracted on the basis of contents of the courses.

36. The method of claim 35, wherein the extraction comprises the steps of:
generating words by performing word segmentation on the contents of the courses;
selecting words whose frequency is higher than a second predefined threshold value and lower than a third predefined threshold value; and
classifying the selected words as keywords and reference context belonging thereto.

37. The method of claim 34, wherein the step of calculating relevance between the user context and the one or more keywords contained in the course as one or more first relevance values respectively comprises the steps of:
calculating relevance between the user context and one or more reference context belonging to each keyword among the one or more keywords, as one or more second relevance values, respectively; and
calculating relevance between the user context and the each keyword on the basis of the one or more second relevance values and weights belonging to respective reference context, as one or more first relevance values.

38. The method of claim 37, further comprising the following step after the step of recommending courses on the basis of the calculated relevance to the user client:
collecting feedback from the user client; and
adjusting weights belonging to respective reference context on the basis of the feedback.

39. The method of claim 33, wherein the step of recommending courses on the basis of the calculated relevance to the user client comprises recommending courses whose relevance is higher than a first predefined threshold value to the user client.

40. The method of claim 33, wherein the courses are mobile courses.

41. The method of claim 33, wherein the reference context include one or more of time, location, season, weather, environment, and event.

42. A system for recommending courses, comprising a user client, a storage device, and a recommending apparatus, the recommending apparatus comprising:
a first receiver adapted to receive a course request from the user client;
a first collector adapted to collect user context related to the user client, wherein the user context includes one or more of time, location, season, weather, environment, and event;
a first calculator adapted to calculate relevance between the user context and each course stored in the storage device; and
a first recommender adapted to recommend courses on the basis of the calculated relevance to the user client.

43. The system of claim 42, wherein the user client is a mobile device, and communicates with the apparatus via a mobile network.

44. A non-transitory computer-readable medium, having stored thereon computer-executable code for execution by a processor, wherein the computer-executable code is configured so that the computer-executable code, when executed by the processor, causes the processor to:
receive a course request from a user client;
collect user context related to the user client, wherein the user context includes one or more of time, location, season, weather, environment, and event;
calculate relevance between the user context and each course stored in a storage device; and
recommend courses on the basis of the calculated relevance to the user client.

45. A system for recommending courses, comprising:
a storage device adapted to store courses;
a user client comprising a third collector adapted to collect user context related to the user client and a transmitter adapted to transmit a course request and the user context to an apparatus for recommending courses, wherein the user context includes one or more of time, location, season, weather, environment, and event; and
the apparatus for recommending courses, comprising a second receiver adapted to receive the course request and the user context from the user client, a sixth calculator adapted to calculate relevance between the user context and each course stored in the storage device, and a second recommender adapted to recommend courses on the basis of the calculated relevance to the user client.
